(19) United States
(12) Patent Application Publication
(10) Pub. No.: US 2018/0331348 A1
(43) Pub. Date: Nov. 15, 2018

(54) ALUMINUM ALLOY PLATE FOR BUS BARS, WHICH HAS EXCELLENT LASER WELDABILITY

(71) Applicant: Kabushiki Kaisha Kobe Seiko Sho (Kobe Steel, Ltd.), Kobe-shi (JP)

(72) Inventor: Kazunori KOBAYASHI, Tochigi (JP)

(73) Assignee: Kabushiki Kaisha Kobe Seiko Sho (Kobe Steel, Ltd.), Kobe-shi (JP)

(21) Appl. No.: 15/773,208

(22) PCT Filed: Oct. 27, 2016
(86) PCT No.: PCT/JP2016/081815

§ 371 Date: May 3, 2018

(30) Foreign Application Priority Data
Nov. 5, 2015 (JP) 2015-217392

(51) Int. Cl. H01M 2/22; H01M 2/30; C22C 21/00

(52) U.S. Cl. CPC H01M 2/22; C22F 1/04; C22C 21/00; H01M 2/30

(57) ABSTRACT

This aluminum alloy plate for bus bars contains Si, Fe, Ti and B respectively in specific amounts, with the balance being made up of Al and unavoidable impurities. With respect to this aluminum alloy plate for bus bars, the number density of intermetallic compounds having maximum lengths of 2 μm or more is 400-1,500 compounds/mm² in a cross-section of ¼ of the plate thickness; and the electrical conductivity is 58-62% IACS.

### TECHNICAL FIELD

The present invention relates to an aluminum alloy sheet for, for example, a bus bar for use as a bus bar of a car, and particularly relates to an aluminum alloy sheet for a bus bar excellent in laser weldability.

### BACKGROUND ART

An aluminum alloy material light in weight has been studied to be used as a bus bar for electrically connecting external terminals of a lithium ion secondary battery for a car or the like with each other.

Patent Literature 1 suggests that different-polarity external terminals of a rectangular secondary battery such as a lithium ion secondary battery are connected with each other through a bus bar made of an aluminum material. The bus bar made of the aluminum material is welded with the external terminals made of an aluminum material by laser welding or electron beam welding.

Patent Literature 2 discloses a bus bar made of an aluminum material and connecting positive and negative terminals of a secondary battery such as a lithium ion secondary battery. The bus base is welded with the positive and negative terminals by laser welding. The aluminum material is pure aluminum or an aluminum alloy containing Fe: 0.50 mass % or less, Si: 0.5 mass % or less, and 0.01 to 0.10 mass % of each of Ti and B, and the total content of Ti and B is 0.15 mass % or less. In the paragraph 0015 of the same literature, aluminum materials 1050, 1080, 1100, 2024, 5052 and 7N71 according to the JIS Standard are listed up specifically. Ti and B are added to such an aluminum material in order to improve the bonding strength (compensate reduction in bonding strength caused by suppressing the contents of Fe and Si to be low).

Patent Literature 3 suggests that an aluminum alloy can be used as an electrically connecting member (such as a bus bar) to be mechanically joined (by bolting, riveting or the like) to a member to be joined. In the paragraph 0015 of the same literature, materials 6101-T6 and 1100-H24 according to the JIS Standard are listed up as specific examples of the aluminum alloy.

Patent Literature 4 discloses an aluminum alloy sheet material excellent in thermal conductivity (electric conductivity). The aluminum alloy sheet material contains Si: 0.15 mass % or less, Fe: 1.00 to 1.60 mass %, Ti: 0.005 to 0.02 mass %, Zr: 0.0005 to 0.03 mass %, and Mn: 0.01 to 0.50 mass % if necessary, with the remainder being Al and unavoidable impurities.

### CITATION LIST

### Patent Literature

Patent Literature 1: Domestic Re-publication of PCT Application 2013/065523
Patent Literature 2: JP-A-2011-171080
Patent Literature 3: JP-A-2015-65105
Patent Literature 4: JP-A-2015-127449

### SUMMARY OF THE INVENTION

### Problem that the Invention is to Solve

An aluminum material is comparatively high in electric conductivity, and lighter in weight than a copper material. Therefore, the aluminum material has been, for example, studied as application to a bus bar for a car. As disclosed in Patent Literatures 1 to 3, an aluminum material for a car bus bar is bent in accordance with necessary, and connected to external terminals of a lithium ion secondary battery or the like by laser welding or mechanical joining (such as bolting). In comparison between the laser welding and the mechanical joining, the former can reduce electric resistance between the bus bar and each of the terminals without another joining member (bolt, nut, etc.). Thus, the laser welding is advantageous to reduce the number of components and reduce the weight.

However, when the aluminum material is subjected to the laser welding, there arises such a problem that the penetration depth of the aluminum material is so shallow that required bonding strength cannot be obtained, or a bead defect portion appears locally (for example, see JP-A-2009-287116, JP-A-2013-087304, etc.). In addition, some composition of the aluminum material or some degree of the bending causes surface roughening or cracking in the bent part.

The present invention has been developed in consideration of the aforementioned problems in the case where a bus bar made of an aluminum material is laser-welded to external terminals of a lithium ion secondary battery or the like. An object of the invention is to provide an aluminum alloy sheet for a bus bar comparatively high in electric conductivity and excellent in laser weldability and bendability.

An aluminum alloy sheet for a bus bar according to the present invention contains Si: 0.35 mass % or less, Fe: 0.15 to 0.60 mass %, Ti: 0.10 mass % or less, and B: 1 to 6 ppm, with the remainder being Al and unavoidable impurities, wherein a number density of an intermetallic compound having a maximum length of 2 μm or more is 400 to 1,500 compounds/mm² at ¼ of a sheet thickness thereof in cross-section, and an electric conductivity thereof is 58 to 62% IACS. The aluminum alloy sheet may contain one or more kinds of Cu: 0.10 mass % or less, Mn: 0.05 mass % or less, and Mg: 0.05 mass % or less as unavoidable impurities or additive elements.

### Advantage of the Invention

An aluminum alloy sheet according to the invention is comparatively high in electric conductivity and excellent in bendability and laser weldability. The aluminum alloy sheet can be used suitably as a car bus bar to be, for example, bonded to external terminals of a lithium ion secondary battery or the like by laser welding.

### BRIEF DESCRIPTION OF THE DRAWINGS

FIG. 1 is a view showing observation fields of an intermetallic compound by a scanning electron microscope.

### MODE FOR CARRYING OUT THE INVENTION

An aluminum alloy sheet for a bus bar according to the invention will be described more in detail below.

### <Composition of Aluminum Alloy>

An aluminum alloy according to the invention contains Si: 0.35 mass % or less, Fe: 0.15 to 0.60 mass %, Ti: 0.10 mass % or less, and B: 1 to 6 ppm (ppm by mass), with the remainder being Al and unavoidable impurities. In the aluminum alloy according to the invention, desired aluminum purity is 99.0 mass % or more in terms of electric conductivity.

Si solid-dissolved in a matrix is effective in enhancing the strength of the aluminum alloy sheet. The effect is improved with increase in Si content. On the other hand, Si forms an Al—Fe—Si intermetallic compound with Al and Fe. When the Si content exceeds 0.35 mass %, the Al—Fe—Si intermetallic compound is coarsened and increased to reduce the bendability of the aluminum alloy sheet. In addition, when the Si content exceeds 0.35 mass %, the electric conductivity is lowered, and welding cracks are easily generated in laser welding. Therefore, the Si content is 0.35 mass % or less, preferably 0.20 mass % or less, and more preferably 0.08 mass % or less.

Fe solid-dissolved in the matrix is effective in enhancing the strength of the aluminum alloy sheet. However, when the Fe content is lower than 0.15 mass %, the effect of enhancing the strength is insufficient, and the electric conductivity is improved to reduce the penetration amount (penetration depth) in the laser welding. Thus, the bonding strength deteriorates. On the other hand, Fe forms an Al—Fe—Si intermetallic compound with Al and Si. When the Fe content exceeds 0.6 mass %, the number of coarse intermetallic compounds having a maximum length of 2 μm or more increases to lower the bendability of the aluminum alloy sheet. Therefore, the Fe content is set at 0.15 to 0.6 mass %.

Ti is effective in micronizing and homogenizing (stabilizing) a cast structure of the aluminum alloy and preventing casting cracks. Preferably 0.003 mass % or more of Ti is added. The Ti content is more preferably 0.005 mass % or more. On the other hand, when Ti is contained excessively, the coarse intermetallic compound is formed to lower the bendability of the aluminum alloy sheet. Therefore, the Ti content is set at 0.1 mass % or less.

B is an element which is regularly used together with Ti as a Ti—B base alloy in order to prevent casting cracks during formation of a slab of the aluminum alloy. In addition, normally 1 ppm or more of B is contained as an impurity in a raw material metal of aluminum. On the other hand, when the B content exceeds 6 ppm, a defect portion in which penetration is deeper than necessary may appear in a solidified bead by laser welding (such as CW (continuous oscillation type (CW) laser welding), or an undercut may occur in the solidified bead. Further, a porosity defect may be left behind in the solidified bead. At a place where the defect portion appears, the bead width is expanded so that the bead width becomes uneven in a longitudinal direction. Therefore, the B content is set at 1 to 6 ppm.

The aluminum alloy according to the invention may contain one or more kinds of Cu, Mn and Mg as unavoidable impurities or additive elements if necessary.

Of these, Cu is effective in enhancing the strength of the aluminum alloy sheet by solid-solution hardening. On the other hand, with increase in Cu content, the welding cracking resistance in the laser welding tends to deteriorate. In addition, when Cu is added, the material cost is increased. Therefore, the Cu content is limited to 0.10 mass % or less (including 0 mass %).

Mn solid-dissloved in the matrix is effective in enhancing the strength of the aluminum alloy sheet. On the other hand, when Mn is added, the material cost is increased. Therefore, the Mn content is limited to 0.05 mass % or less (including 0 mass %).

Mg solid-dissolved in the matrix is effective in enhancing the strength of the aluminum alloy sheet. On the other hand, when the Mg content is increased, a shape of a welding bead may be disordered in laser welding (such as CW (continuous oscillation type (CW) laser welding), or a defect may be easily generated internally. In addition, when Mg is added, the material cost is increased. Therefore, the Mg content is limited to 0.05 mass % or less (including 0 mass %).

In addition, the aluminum alloy according to the invention may contain, as unavoidable impurities, elements other than the aforementioned elements.

Of the unavoidable impurities, Zn is low in vapor pressure. Accordingly, Zn scattered during laser welding is apt to contaminate the surroundings to thereby deteriorate the laser weldability of the aluminum alloy sheet. Therefore, the Zn content is limited to 0.1 mass % or less (including 0 mass %).

The contents of unavoidable impurity elements other than Zn are limited within ranges specified in the field of other elements of alloy number 1100 in JIS H4000:2014. Specific examples of the unavoidable impurity elements other than Zn may include Cr, Zr, V, Ni, Sn, In, Ga, etc. The content of each of the elements is limited to 0.05 mass % or less, and the total content of the elements is limited to 0.15 mass % or less. When the elements are within those ranges, the effect of the invention is not impaired by the elements not only when they are contained as unavoidable impurities but also even when they are added positively.

### <Number Density of Intermetallic Compound Having Maximum Length of 2 μm or More>

In the aluminum alloy sheet according to the invention, an Al—Fe and Al—Fe—Si compound is a major intermetallic compound. In the composition of the aluminum alloy sheet, when the number density of the coarse intermetallic compound having a maximum length of 2 μm or more is less than 400 compounds/mm², the electric conductivity of the aluminum alloy sheet is lowered due to a large amount of solid-dissolved Fe, Si, etc. There is a case that the number density of the coarse intermetallic compound is less than 400 compounds/mm² because the Fe content is insufficient. In this case, the amount of solid-dissolved Fe, Si, etc. is also small, and the aluminum alloy sheet is good in electric conductivity. Thus, the penetration amount (penetration depth) in laser welding is reduced so that the bonding strength deteriorates. On the other hand, when the number density of the intermetallic compound having a maximum length of 2 μm or more is more than 1,500 compounds/mm², the bendability of the aluminum alloy sheet deteriorates. Therefore, the number density of the intermetallic compound with a maximum length of 2 μm or more is set at 400 to 1,500 compounds/mm².

### <Electric Conductivity of Aluminum Alloy Sheet>

The aluminum alloy sheet is more excellent in thermal conductivity, that is, electric conductivity than a steel sheet or a stainless steel sheet. Accordingly, larger laser energy is required to obtain the same penetration depth in laser welding. When the content of other alloy elements (Si, Fe, Cu, Mn, Mg, Ti, etc.) than aluminum is large, the electric conductivity and the thermal conductivity deteriorate due to solid solution of those elements. Thus, the penetration depth in the laser welding is increased. On the contrary, when the content of the other alloy elements than aluminum is small and the purity of aluminum is high, the electric conductivity and the thermal conductivity are so high that the penetration depth is apt to be shallow. In the aluminum alloy sheet according to the invention, when the electric conductivity is 62% IACS or less, the penetration depth in the laser welding can be made deep enough to obtain high joint strength. On the other hand, when the content of the other alloy elements than aluminum is large and the electric conductivity is low, the aluminum alloy sheet deteriorates in electric conductivity as a bus bar which is an electric connection component. When the electric conductivity of the aluminum alloy sheet is 58% IACS or more, sufficient electric conductivity as a bus bar can be secured. Therefore, the electric conductivity of the aluminum alloy sheet is set within a range of 58 to 62% IACS.

### <Method for Manufacturing Aluminum Alloy Sheet>

A usual method may be used as a method for manufacturing the aluminum alloy sheet according to the invention. For example, the method includes the steps of semi-continuous casting (DC (Direct Chill) casting), homogenizing, hot rolling, cold rolling, and final annealing. The number density of the intermetallic compound having a maximum length of 2 μm or more is reduced as the cooling rate during the casting is increased. In the aluminum alloy sheet having the composition according to the invention, it is preferable to set the cooling rate during the casting at 0.1 to 1.0° C./sec in order to set the number density of the intermetallic compound having a maximum length of 2 μm or more within the aforementioned range. The cooling rate is more preferably 0.1 to 0.5° C./sec.

### Example 1

Examples in which the effect of the invention was confirmed will be described specifically below in contrast with comparative examples which did not satisfy the requirements of the invention. The invention is not limited to the examples.

Each of aluminum alloys (No. 1 to 28) having compositions shown in Table 1 was melted and cast to manufactured a slab, and the slab was scalped. In the casting, the cooling rate was set at 0.4° C./sec. The slab was homogenized at 570° C., and then rolled into a hot-rolled sheet having a thickness of 5 mm. After that, the hot-rolled sheet was subjected to cold rolling to manufacture a cold-rolled sheet having a thickness of 2 mm. The cold-rolled sheet was further annealed at 350° C. to obtain an annealed material of the aluminum alloy sheet.

TABLE 1

| | component composition of material (mass %, ppm in B) | | | | | | | |
|---|---|---|---|---|---|---|---|---|
| No. | Si | Fe | Cu | Mn | Mg | Ti | B | Al |
| 1 | 0.02 | 0.30 | — | — | — | 0.01 | 2 | remainder |
| 2 | 0.05 | 0.30 | — | 0.01 | 0.01 | 0.01 | 3 | remainder |
| 3 | 0.15 | 0.30 | 0.01 | — | 0.01 | 0.01 | 4 | remainder |
| 4 | 0.32 | 0.30 | 0.01 | 0.01 | — | 0.01 | 5 | remainder |
| 5 | 0.05 | 0.18 | 0.01 | 0.01 | 0.01 | 0.01 | 3 | remainder |
| 6 | 0.05 | 0.45 | 0.01 | 0.01 | 0.01 | 0.01 | 4 | remainder |
| 7 | 0.05 | 0.56 | 0.01 | 0.01 | 0.01 | 0.01 | 5 | remainder |
| 8 | 0.05 | 0.30 | 0.04 | 0.01 | 0.01 | 0.01 | 3 | remainder |
| 9 | 0.05 | 0.30 | 0.08 | 0.01 | 0.01 | 0.01 | 3 | remainder |
| 10 | 0.05 | 0.30 | 0.01 | 0.04 | 0.01 | 0.01 | 4 | remainder |
| 11 | 0.05 | 0.30 | — | — | 0.04 | 0.01 | 3 | remainder |
| 12 | 0.05 | 0.30 | 0.01 | — | — | 0.01 | 4 | remainder |
| 13 | 0.05 | 0.30 | — | 0.01 | — | 0.04 | 5 | remainder |
| 14 | 0.05 | 0.30 | 0.01 | 0.01 | 0.01 | 0.08 | 5 | remainder |
| 15 | 0.05 | 0.30 | 0.01 | 0.01 | 0.01 | 0.01 | 5 | remainder |
| 16 | 0.03 | 0.24 | 0.03 | 0.02 | 0.03 | 0.02 | 4 | remainder |
| 17 | 0.20 | 0.35 | 0.02 | 0.03 | 0.02 | 0.01 | 3 | remainder |
| 18 | 0.08 | 0.28 | 0.02 | 0.01 | 0.02 | 0.05 | 5 | remainder |
| 19 | 0.40* | 0.30 | 0.01 | 0.01 | 0.01 | 0.01 | 3 | remainder |
| 20 | 0.05 | 0.12* | 0.01 | 0.01 | 0.01 | 0.01 | 5 | remainder |
| 21 | 0.05 | 0.65* | 0.01 | 0.01 | 0.01 | 0.01 | 5 | remainder |
| 22 | 0.05 | 0.30 | 0.01 | 0.01 | 0.01 | 0.13* | 150* | remainder |
| 23 | 0.05 | 0.30 | 0.01 | 0.01 | 0.01 | 0.01 | 7* | remainder |
| 24 | 0.05 | 0.30 | 0.01 | 0.01 | 0.01 | 0.02 | 10* | remainder |
| 25 | 0.45* | 0.75* | 0.03 | 0.02 | 0.03 | 0.01 | 5 | remainder |
| 26 | 0.38* | 0.70* | 0.06 | 0.03 | 0.07* | 0.02 | 12* | remainder |
| 27 | 0.15 | 0.62* | 0.12* | 0.08* | 0.02 | 0.03 | 9* | remainder |
| 28 | 0.20 | 0.30 | 0.03 | 0.03 | 0.07* | 0.03 | 8* | remainder |

*item out of range specified by the invention

As for each of the aluminum alloy sheets of No. 1 to 28, the number density of an intermetallic compound having a maximum length of 2 μm or more, the electric conductivity, the mechanical properties, the laser weldability (penetration depth and welding appearance), and the bendability were measured in the following manners. Results of the measurements are shown in Table 2.

TABLE 2

| | mechanical properties | | | number density | | | | |
|---|---|---|---|---|---|---|---|---|
| | tensile | proof | | of intermetallic | | laser weldability | | |
| | strength | stress | elongation | compound | electric | penetration | welding | |
| No. | (MPa) | (MPa) | (%) | (compounds/mm²) | conductivity | depth | appearance | bendability |
| 1 | 79 | 31 | 43 | 540 | ◯ | ◯ | ◯ | ◯ |
| 2 | 82 | 33 | 42 | 820 | ◯ | ◯ | ◯ | ◯ |
| 3 | 84 | 34 | 40 | 1030 | ◯ | ◯ | ◯ | ◯ |
| 4 | 87 | 35 | 37 | 1250 | ◯ | ◯ | ◯ | ◯ |
| 5 | 80 | 31 | 42 | 710 | ◯ | ◯ | ◯ | ◯ |
| 6 | 85 | 35 | 35 | 1290 | ◯ | ◯ | ◯ | ◯ |
| 7 | 87 | 37 | 33 | 1430 | ◯ | ◯ | ◯ | ◯ |
| 8 | 84 | 35 | 40 | 850 | ◯ | ◯ | ◯ | ◯ |
| 9 | 86 | 38 | 39 | 870 | ◯ | ◯ | ◯ | ◯ |
| 10 | 84 | 35 | 41 | 860 | ◯ | ◯ | ◯ | ◯ |
| 11 | 86 | 36 | 40 | 830 | ◯ | ◯ | ◯ | ◯ |
| 12 | 83 | 33 | 41 | 840 | ◯ | ◯ | ◯ | ◯ |
| 13 | 83 | 34 | 42 | 830 | ◯ | ◯ | ◯ | ◯ |
| 14 | 85 | 35 | 40 | 820 | ◯ | ◯ | ◯ | ◯ |
| 15 | 82 | 34 | 41 | 830 | ◯ | ◯ | ◯ | ◯ |
| 16 | 80 | 32 | 43 | 750 | ◯ | ◯ | ◯ | ◯ |
| 17 | 86 | 34 | 38 | 1050 | ◯ | ◯ | ◯ | ◯ |
| 18 | 79 | 32 | 42 | 920 | ◯ | ◯ | ◯ | ◯ |
| 19 | 85 | 35 | 39 | 1580* | X | ◯ | X | X |
| 20 | 78 | 28 | 43 | 370* | X | X | ◯ | ◯ |
| 21 | 89 | 36 | 35 | 1570* | ◯ | ◯ | ◯ | X |
| 22 | 85 | 34 | 41 | 810 | ◯ | ◯ | X | X |
| 23 | 83 | 34 | 42 | 830 | ◯ | ◯ | X | ◯ |
| 24 | 83 | 32 | 43 | 830 | ◯ | ◯ | X | ◯ |
| 25 | 89 | 37 | 35 | 2020* | X | ◯ | X | X |
| 26 | 92 | 43 | 38 | 1960* | X | ◯ | X | X |
| 27 | 93 | 44 | 38 | 1980* | ◯ | ◯ | X | X |
| 28 | 90 | 39 | 38 | 920 | ◯ | ◯ | X | ◯ |

*item out of range specified by the invention

### (Measurement of Number Density of Intermetallic Compound Having Maximum Length of 2 μm or More)

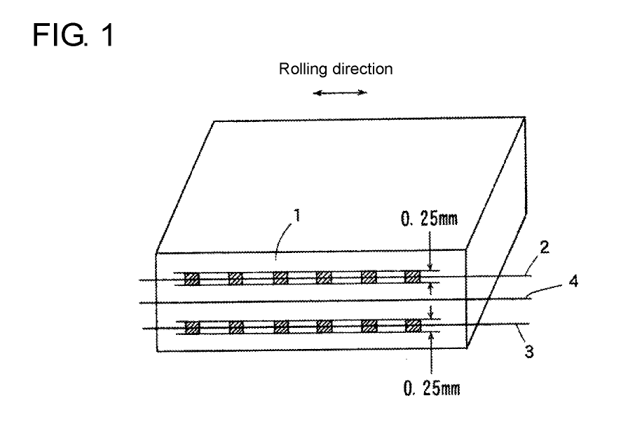

A test piece was cut out from each of the aluminum alloy sheets, and buried into resin so that a section including a rolling direction and a sheet thickness direction was a surface to be observed. The surface to be observed was polished into a mirror surface. Using a scanning electron microscope (JSM-7001F manufactured by JEOL Ltd.), 20 visual fields (totally 0.4 mm²) of the surface to be observed were observed in a magnification ratio of 500 times and with an acceleration voltage of 20 kV to obtain a COMPO image (composition image). As the observed visual fields, as shown in FIG. 1, 10 visual fields (totally 20 visual fields) were selected from each of upper and lower regions above and under the center (line 4) of the sheet thickness of the surface to be observed 1. Each region corresponded to ¼ of the sheet thickness (that is, within a region 0.25 mm wide around a position (line 2 or 3) corresponding to ¼ of the sheet thickness). Each part observed to be whiter than the matrix in the COMPO image was regarded as a particle of an Al—Fe or Al—Fe—Si intermetallic compound. Using particle analyzing software Ex-3511 built in the scanning electron microscope, the number of particles having an absolute maximum length of 2 μm or more was counted to calculate the number density. The absolute maximum length means a maximum value of a distance between any two points on the outline of each particle.

### (Measurement of Electric Conductivity)

Using an eddy current conductivity measuring apparatus manufactured by Institute Dr. Foerster GmbH & Co. KG (tradename SIGMATEST, model number 2.068), the electric conductivity of each aluminum alloy sheet was measured according to the specification of JIS H0505:1975. When the electric conductivity was 58% IACS or higher and 62% IACS or lower, the electric conductivity was evaluated as good “◯”. When the electric conductivity was lower than 58% IACS or higher than 62% IACS, the electric conductivity was evaluated as not good “x”.

### (Measurement of Mechanical Properties)

A test piece of JIS No. 5 (JIS Z2201:2009) was cut out from each aluminum alloy sheet so that the tensile direction was parallel with the rolling direction. Using the test piece, a tensile test according to JIS Z2241:2009 was performed to measure the tensile strength, the proof stress (0.2% proof stress) and the elongation.

### (Welding Appearance)

A test piece measuring 30 mm×100 mm was cut out from each aluminum alloy sheet, and subjected to bead-on-plate welding with a welding length of 90 mm by use of a welding machine using a continuous oscillation type fiber laser (model: YLR-1000, manufactured by IPG Photonics Japan Limited) as a heat source. The welding was performed on welding conditions of a laser output power of 2.0 kW, a welding rate of 10.0 m/min, and an angle of advance of 5 deg. Each welding bead portion was observed as to the existence of welding cracking, the uniformity of welding bead width, the existence of undercut, and the existence of welding sputter adhesion. As a result, the welding appearance was evaluated as good “0” for a sheet where cracking did not occur in the welding bead portion, the welding bead width was uniform, no undercut, no bumping portion and no sputter adhesion with a diameter of 1 mm or more were observed in the welding bead portion. Otherwise, the welding appearance was evaluated as not good “x” for any sheet.

### (Penetration Depth)

After the observation of the welding appearance, the penetration depth of the welding bead was measured using the same test piece. The test piece was cut in a section perpendicular to the welding direction and at a central position of the welding bead length (or near a defect portion if such a defect portion occurred in the central position). The section of the welding bead portion was observed by an optical microscope to measure the penetration depth. A sheet with a penetration depth of 700 μm or more was evaluated as good “◯”. A sheet with a penetration depth less than 700 μm was evaluated as not good “x”.

### <Bendability>

Five test pieces of JIS No. 3 (JIS Z2204:2009) were cut out from each aluminum alloy sheet so that the longitudinal direction was perpendicular to the rolling direction. Each test piece (30 mm wide) was bent at a bending angle of 120 degrees using a pressing metal tool with a front end angle of 60 degrees by a V-block method according to JIS Z2248:2006. After that, the test piece was squeezed by a flat metal tool. Thus, close-contact bending at a bending angle of 180 degrees was performed. The outside of a bent portion (curved portion) of the test piece subjected to the close-contact bending was observed all over the width of 30 mm. A sheet where surface roughening and cracking did not occur in all the test pieces was evaluated as good “0”, and a sheet where surface roughening or cracking occurred in at least one of the test pieces was evaluated as not good “x”.

As shown in Tables 1 and 2, the sheets of No. 1 to 18 satisfying the specification of the invention as to the alloy composition, the number density of the intermetallic compound having a maximum length of 2 μm or more at ¼ of the sheet thickness in cross-section, and the electric conductivity were evaluated as good in both the laser weldability and the bendability. In addition, each of the sheets of No. 1 to 18 also had mechanical properties with which the sheet can be used as a car bus bar.

On the other hand, the sheets of No. 19 to 28 which did not satisfy the specification of the invention as to at least one of the alloy composition, the number density of the intermetallic compound, and the electric conductivity were evaluated as not good in the laser weldability and/or the bendability. Specific results will be shown below.

The sheet of No. 19 was low in electric conductivity due to the excessive Si content. Thus, welding cracks occurred to deteriorate the welding appearance. In addition, the sheet of No. 19 was inferior in bendability due to the excessive number density of the intermetallic compound.

The sheet of No. 20 had an insufficient Fe content. Therefore, the sheet of No. 20 was high in electric conductivity, low in number density of the intermetallic compound, and insufficient in penetration depth during laser welding.

The sheet of No. 21 had an excessive Fe content. Therefore, the sheet of No. 21 was too high in number density of the intermetallic compound, and inferior in bendability.

In each of the sheets of No. 22 to 24 and 26 to 28, a defect portion occurred in a welding bead due to the excessive B content. Thus, the welding bead width became uneven, and an undercut occurred in the welding bead. The sheets of No. 25 and 26 were low in electric conductivity due to the excessive Si content, and welding cracks also occurred in the sheet of No. 25. The sheet of No. 22 was inferior in bendability due to the excessive Ti content. Each of the sheets of No. 25 to 27 was excessive in number density of the intermetallic compound and inferior in bendability due to the excessive Si and Fe contents in each of the sheets of No. 25 and 26 and due to the excessive Fe content in the sheet of No. 27.

### Example 2

The aluminum alloy of the composition shown as No. 2 in Table 1 was melted and cast at various cooling rates shown in Table 3 to manufacture slabs. Each of the slabs was subjected to the same manufacturing steps on the same conditions as in Example 1 to manufacture a cold rolled sheet having a thickness of 2 mm. Further, the cold rolled sheet was annealed at 350° C. to obtain an annealed material of an aluminum alloy sheet.

For each of the aluminum alloy sheets (No. 2-1 to 2-5) shown in Table 3, the number density of an intermetallic compound with a maximum length of 2 μm or more, the electric conductivity, and the bendability were measured in the same manner as in Example 1. Results of the measurements are shown in Table 3.

TABLE 3

| | cooling | mechanical properties | | | number density | | | | |
|---|---|---|---|---|---|---|---|---|---|
| | rate in | tensile | proof | | of intermetallic | | laser weldability | | |
| | casting | strength | stress | elongation | compound | electric | penetration | welding | |
| No. | (° C./sec) | (MPa) | (MPa) | (%) | (compounds/mm²) | conductivity | depth | appearance | bendability |
| 2-1 | 0.05 | 78 | 30 | 44 | 1550 | X | X | ◯ | X |
| 2-2 | 0.15 | 80 | 32 | 42 | 1320 | ◯ | ◯ | ◯ | ◯ |
| 2-3 | 0.4 | 82 | 33 | 42 | 820 | ◯ | ◯ | ◯ | ◯ |
| 2-4 | 1.3 | 84 | 34 | 42 | 380 | X | ◯ | ◯ | ◯ |
| 2-5 | 5.0 | 86 | 35 | 41 | 290 | X | ◯ | X | ◯ |

As shown in Table 3, in each of the sheets of No. 2-2 and 2-3 in which the cooling rate in casting was within a range of 0.1 to 1.0° C./sec, the number density of the intermetallic compound was within the range specified by the invention, the electric conductivity was good (58% IACS or higher and 62% IACS or lower), and the laser weldability and the bendability were good. In addition, each of the sheets 2-2 and 2-3 had mechanical properties with which the sheet can be used as a car bus bar.

On the other hand, in the sheet of No. 2-1 where the cooling rate in casting was 0.05° C., the number density of the intermetallic compound was excessive, the electric conductivity was not good (higher than 62% IACS), the penetration depth was insufficient, and the bendability was inferior. It can be considered that the reason why the electric conductivity was not good (higher than 62% IACS) in the sheet of No. 2-1 was because the amount of solid-dissolved Fe, Si, etc. was reduced.

In each of the sheet of No. 2-4 where the cooling rate in casting was 1.3° C./sec and the sheet of No. 2-5 where the cooling rate was 5.0° C./sec, the number density of the intermetallic compound was low, and the electric conductivity was not good (lower than 58% IACS). It can be considered that the reason why the electric conductivity was not good (lower than 58% IACS) in each of the sheets of No. 2-4 and 2-5 was because the amount of solid-dissolved Fe, Si, etc. was increased.

The invention has been described in detail and with reference to its specific embodiment. It is however obvious for those in the art that various changes or modifications can be made on the invention without departing from the spirit and scope of the invention.

The present application is based on a Japanese patent application (Japanese Patent Application No. 2015-217392) filed on Nov. 5, 2015, the contents of which are incorporated herein by reference.

### INDUSTRIAL APPLICABILITY

An aluminum alloy sheet according to the invention is comparative high in electric conductivity and excellent in bendability and laser weldability. Accordingly, the aluminum alloy sheet is useful as a car bus bar to be bonded, for example, to external terminals of a lithium ion secondary battery by laser welding.

### DESCRIPTION OF REFERENCE NUMERALS AND SIGNS

1 surface to be observed
2, 3 line designating a position corresponding to ¼ of sheet thickness in a sheet section
4 line designating a central position of sheet thickness in the sheet section

1. An aluminum alloy sheet for a bus bar excellent in laser weldability, the aluminum alloy sheet comprising:
Si: 0.35 mass % or less;
Fe: 0.15 to 0.60 mass %;
Ti: 0.10 mass % or less;
B: 1 to 6 ppm; and
Al and unavoidable impurities,
wherein:
a number density of an intermetallic compound having a maximum length of 2 μm or more is 400 to 1,500 compounds/mm² at ¼ of a sheet thickness thereof in cross-section; and
an electric conductivity is 58 to 62% IACS.

2. The aluminum alloy sheet according to claim 1, further comprising at least one of:
Cu: 0.10 mass % or less;
Mn: 0.05 mass % or less; and
Mg: 0.05 mass % or less.
